(19) United States
(12) Patent Application Publication
(10) Pub. No.: US 2002/0081387 A1
(43) Pub. Date: Jun. 27, 2002

(54) Method of reinforcing flat materials, especially two-dimensional textile structures

(76) Inventors: Albrecht Kaiser, Vlotho (DE); Michael Dressler, Lage (DE)

Correspondence Address: TECHNOPROP COLTON, L.L.C., P O BOX 567685, ATLANTA, GA, 311567685

(21) Appl. No.: 09/947,902

(22) Filed: Sep. 6, 2001

(30) Foreign Application Priority Data
Sep. 18, 2000 (DE) 10046403.3
Oct. 7, 2000 (DE) 10049706.3

(51) Int. Cl. B05D 1/02

(52) U.S. Cl. 427/421

(57) ABSTRACT

When reinforcing two-dimensional textile structures, in particular outer material blanks (17), separate interlining material blanks are normally used. These have to be cut to size separately, placed in an accurately positioned manner on the outer material blanks (17) by hand and adhesively bonded to the outer material blanks (17). This is extremely complicated.

The invention proposes a method of reinforcing two-dimensional textile structures, in particular outer material blanks (17), in which the reinforcements, of free-flowing substances, is sprayed or printed in a specifically positioned manner onto the outer material blanks (17), in particular material webs (15), in order to form the said reinforcement. As a result, the cutting, positioning and adhesive bonding of separate interlining material blanks are dispensed with, In addition, provision is made to use free-flowing substances of different type and/or inhomogeneous substances for the reinforcement. This makes it possible to form reinforcements with any desired characteristics and styles.

The invention relates to a method of reinforcing flat materials, especially two-dimensional textile structures, according to the precharacterizing clause of claim 1 and 16.

Flat materials, to be specific especially those made of fabrics, knitted materials or possibly also nonwoven fabrics, are used to produce items of clothing or else other textiles and articles. These materials are often provided with a partial or else complete reinforcement. It is known to bond such materials, which in the specialist jargon are usually referred to as outer materials, adhesively to a separate, flat reinforcing material, interlining materials as they are known. The reinforcement is then formed by the interlining materials adhesively bonded to the outer materials. This known type of reinforcing material of the type mentioned here is quite complicated. It is necessary for the parts of the outer material and the parts of the interlining material, which are generally precoated with a thermoplastic adhesive, to be cut to size separately. The cut-to-size interlining material parts must be positioned exactly on the outer material parts and joined in a fixing machine.

The invention is, then, based on the object of providing a simple and flexible method of reinforcing materials, especially two-dimensional textile structures such as outer material blanks.

A method of achieving this object has the features of claim 1. Because the reinforcement is formed by at least one substance which is applied in the flowing state and deliberately positioned on the material to be reinforced, no separate interlining blanks are needed any more. The positioning of the interlining blanks on the material to be reinforced can therefore be dispensed with. Instead, the reinforcement is formed by at least one substance which, in the flowing state, may be applied specifically to the material to be reinforced.

The reinforcement is preferably formed by the or any free-flowing substance being printed on, sprayed on or applied in any other way to the material to be reinforced. This is preferably carried out under computer control by means of an appropriate application device which, for example, can be constructed in the manner of the printer. As a result, the reinforcement can be applied to the material specifically at the point at which it is required or desired. The reinforcement can have any desired contours as a result of at least one free-flowing substance being printed on or sprayed onto the material to be reinforced. By means of appropriate control of the application device, any desired and even complex contours of the reinforcement may be formed, without additional, separate interlining materials being required and, above all, these not having to be cut out and placed in position on the material blank to be reinforced.

The reinforcement is preferably applied to a continuous web of the material to be reinforced, especially printed on and/or sprayed on or impressed on. In particular in the case of the reinforcement being applied by means of a computer-controlled application device, it is possible to provide the web with reinforcements having appropriate contours, preferably whole-area reinforcements, very closely together with maximum material utilization. In this case, reinforcing the material is possible with maximum utilization of the material of the material web. However, it is also conceivable to apply the reinforcement to finally cut blanks, especially outer material blanks.

The reinforcement is preferably applied to the material web in such a way that the latter extends in the area of subsequent cut edges of the outer material parts and, as a result, the cut edges are consolidated in order to avoid subsequent fraying. However, it is also conceivable to use the application device for the chemical consolidation of the cut edges before the actual cutting to size, by which means, in this way, the subsequent fraying of the edges of the material, in particular of the outer material blanks, after being cut to size is effectively prevented. This measure is primarily advantageous when the reinforcement is not applied to the entire area of the outer material blank, especially when edge regions remain at least to some extent uncoated or unreinforced and, as a result, are not protected against fraying by the coating or reinforcement.

If flat material webs are reinforced, material blanks, especially outer material blanks, are cut out of the said material webs after the application of the reinforcement. Cutting out is preferably carried out after the curing of the sprayable, printable or otherwise free-flowing substance.

A further method for the independent achievement of the object mentioned at the beginning, but also for developing the method described above, especially according to claim 1, has the measures of claim 16. By forming the reinforcement from different substances with different characteristics and/or at least one inhomogeneous substance, it is possible to form the respective reinforcement with portions of the area with different characteristics. it is also possible in this way, using the same application device and in each case using a dedicated applicator nozzle or the like for each substance, if appropriate to produce various reinforcements with different characteristics at the same time. Inhomogeneous substances also permit the formation of reinforcements which, in cross section, have different compositions, especially different characteristics. For example, in this way an underside of the reinforcement adjoining the material to be reinforced and joined to it in this way can have a different composition than the adjacent opposite upper side of the reinforcement.

According to a preferred refinement of all the methods outlined above, it is conceivable to apply a substance used for reinforcement (or a plurality of substances) onto the material with a different thickness. In this way, too, the respective reinforcement can be given areas with different characteristics. In the case of reinforcements of different thickness, these different characteristics can also be achieved with one and the same substance, specifically in particular even with a homogeneous substance.

According to the invention, provision is additionally made to use at least one substance which has additives, specifically, for example, fibres or foam-forming additives. As a result, it is possible for example to structure the outer side of the reinforcement on the material. When fibres are used, the outer side of the reinforcement can be given a construction similar to a nonwoven fabric or an appearance similar to a nonwoven fabric. Foam-forming additives exert an influence on the handleability of the reinforced material and can also be used for the purpose of achieving specific structures on the exposed outer side of the reinforcement.

Preferred exemplary embodiments of the method according to the invention will be explained in more detail below using the drawing, in which:

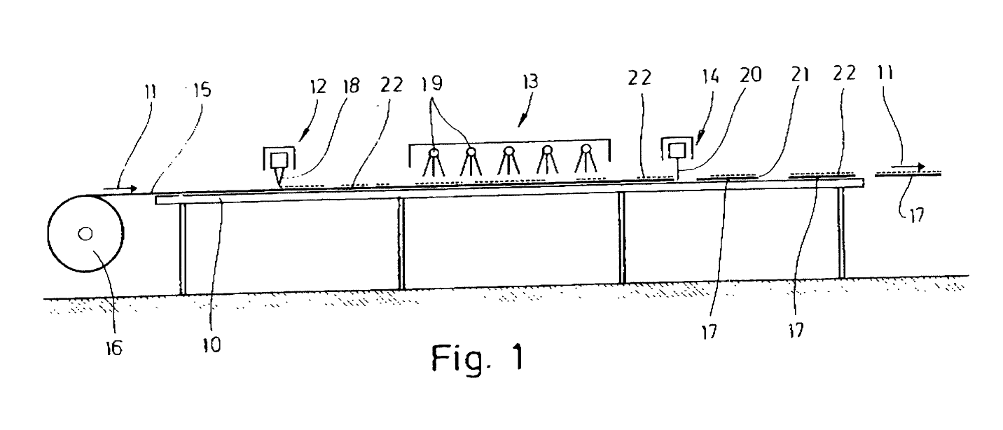

FIG. 1 shows a schematic side view of an apparatus for reinforcing flat materials, and

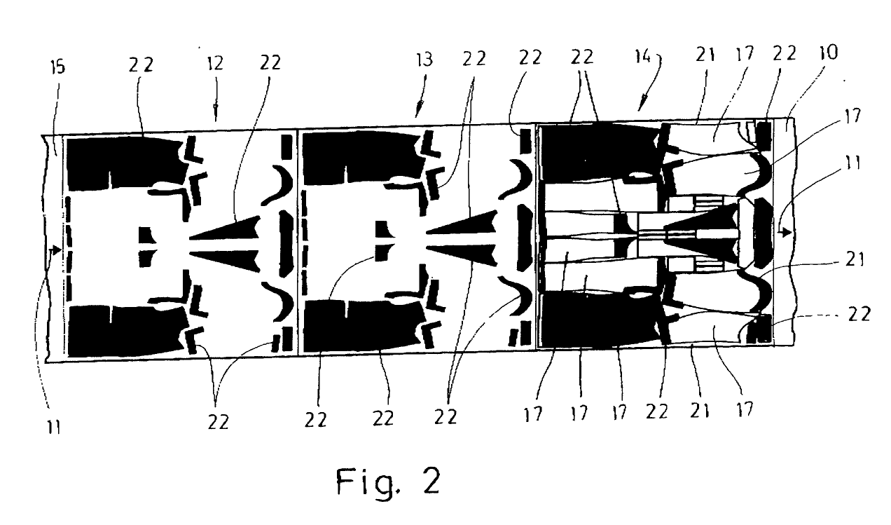

FIG. 2 shows a plan view of the working area of the apparatus of FIG. 1.

The apparatus shown in the figures represents one possible way of implementing the methods according to the invention. The methods according to the invention will be described below in connection with the reinforcement of materials which are two-dimensional textile materials, outer materials, as they are known, or outer material blanks for the production of items of clothing.

In exemplary embodiments shown, the reinforcement of the outer material is carried out on an elongated, flat worktop 10. Associated with the worktop 10, following one another in the treatment direction 11, are an applicator device 12, a drying station 13 and a cutting device 14.

In the present exemplary embodiment, the outer material to be reinforced is cut out from a material web 15, which is preferably formed of a textile material. The material web 15 is unwound, preferably continuously, from a supply roll 16 and is drawn over the worktop 10 in the treatment direction 11. For this purpose, use is made of a transport device (not shown), which follows the worktop 10 in the treatment direction 11. During the treatment, the material web 15 and the outer material blanks 17 cut from it in the cutting device 14 are held on the worktop 10, over the entire area or else only partially, and specifically preferably by vacuum, at least during the application of the reinforcement and the cutting. As a result, slipping of the material web 15 on the worktop 10 during the reinforcement and the cutting out of the outer material blanks 17 is prevented.

The treatment of the material web 15, that is to say the reinforcement and the cutting out of the outer material blanks 17 on the worktop 10, is preferably carried out continuously. Accordingly, the material web 15 is drawn uninterruptedly over the worktop 10 at a substantially constant speed. However, it is also conceivable to carry out the reinforcement and the cutting out of the material web 15 while it is momentarily at a standstill. The material web 15 is then moved discontinuously over the worktop 10 in the treatment direction 11. The reinforcement and the cutting out of the outer material blanks 17 are then carried out during the stop phases of the material web 15. The onward transport of the material web 15 along the worktop 10 from one device or station to another is then carried out only during treatment pauses.

The applicator device 12 illustrated only schematically in FIG. 1 may be a type of printer. For this purpose, in the exemplary embodiment shown, the applicator device 12 has an applicator nozzle 18. However, the applicator device 12 can have a plurality of applicator nozzles 18. The applicator nozzle 18 can be moved along the first station, namely the applicator device 12, of the apparatus under computer control. The applicator device 12 can be constructed in such a way that the applicator nozzle 18 can be moved in different directions, in particular at least two horizontal paths running at right angles to each other. These paths preferably run transversely and longitudinally with respect to the treatment direction 11. Such an applicator device 12 is suitable for applying the reinforcement to the stationary material web 15. However, it is also conceivable to apply the reinforcement from the applicator nozzle 18 onto the material web 15 moved continuously over the worktop 10 in the treatment direction 11. In this case, it may be sufficient for the applicator device 12 to permit the applicator nozzle 18 to move only on one path transversely with respect to the treatment direction 11. A relative movement of the applicator nozzle 18 in relation to the material web 15 in the treatment direction 11 is carried out by means of the onward transport of the material web 15 during the liquid or pasty application of the respective substance.

The drying station 13 following the applicator device 12 in the treatment direction 11 extends transversely over the entire material web 15 and is provided with infrared radiators 19 and/or hot-air nozzles.

Finally, in the treatment direction 11, the drying station 13 is followed by the cutting device 14. The cutting device 14 has at least one cutting means 20 which, like the applicator nozzle 18, can be moved over the entire width of the worktop 10 or at least the material web 15, at least transversely with respect to the treatment direction 11, under computer control. This is sufficient if the cutting of the outer material blanks 17 is carried out as the material web 15 is moved continuously onward. However, it is also conceivable to move the cutting means 20 on many axes with respect to the worktop 10, specifically in particular when the cutting of the reinforcement material web 15 is to be carried out while the latter is at a standstill. The cutting means 20 may be a conventional knife. However, it is also conceivable to employ beams of energy with a high energy density, for example laser or plasma beams, for the cutting.

The methods according to the invention will be explained in more detail below using the apparatus shown in the figures and described above:

The material to be reinforced to form the outer material blanks 17 is formed from a continuous material web 15. A large number of different outer material blanks 17 are formed close beside one another from the material web 15, in order that the material web 15 is utilized in the best possible way and as little waste as possible is produced. The arrangement of the different outer material blanks 17 on the material web 15 is shown in FIG. 2.

The outer material blanks 17 are reinforced either over the entire area or only partially. The areas of the reinforcements are illustrated completely black in FIG. 2. In the right-hand illustration of FIG. 2, the outlines of the outer material blanks 17 are illustrated by black lines, and those areas of the outer material blanks 17 which are reinforced are in turn shown black. Therefore, some outer material blanks 17 are reinforced over their entire area and others only partially.

The reinforcement of the material web 15 or the outer material blanks 17 is carried out in accordance with the method of the invention with the aid of at least one free-flowing substance, which is applied in a specifically positioned way to the material web 15. The material web 15 is therefore given a single-sided coating with the free-flowing or sprayable substance or, if appropriate, even a plurality of substances in some areas, specifically at the envisaged points, on its exposed upper side.

The free-flowing substance in the exemplary embodiment shown is applied by means of the applicator nozzle 18, specifically sprayed on. In this case, the applicator nozzle 18 is a spray nozzle, which applies both a jet and successive points of the free-flowing substance to the material web 15 for the purpose of reinforcement. In this case, the applicator nozzle 18 of the applicator device 12 is moved under computer control over the worktop 10 in such a way that, in the areas of the reinforcement, the material web 15 is given a full-area coating with the substance used for the reinforcement, and the outlines of the areas of free-flowing or sprayable substance applied to the material web 15 by the applicator nozzle 18 correspond to the outlines of the reinforcement and/or the outer material blanks. In this way, by the method according to the invention, the substance or, if appropriate, even a plurality of substances is or are applied to the material web 15 by a type of pulse pressure which, in terms of its mode of operation, is similar to inkjet printers.

The applicator device 12 can also be used at the same time to consolidate, specifically preferably chemically, cut edges 21 along which the outer material blanks 17 are cut from the material web 15. In addition, at the same time as the reinforcement is applied by the applicator device 12, it is possible to print the material web 15 with markings for the cutting operation or pass marks for subsequent seaming operations. If appropriate, numbers for numbering the outer material blanks 17 cut from the material web 15 can also be applied by the applicator device 12.

A further method, which can preferably be used as a continuation of the method described above, provides for the formation of at least some reinforcements 22 of the material web 15 by free-flowing substances with different characteristics and/or at least one inhomogeneous substance.

If substances with different characteristics are used, the applicator device 12 preferably has a corresponding number of applicator nozzles 18. By means of the various substances, reinforcements 22 with different characteristics may be formed. This can be done in such a way that the material web 15 is provided with different substances, by printing, spraying on or the like, in the areas of different outer material blanks 17. However, it is also conceivable to form the reinforcement of the same outer material blank 17 from different substances, so that the outer material blank 17 has a reinforcement with partially different characteristics. It is also conceivable to arrange different substances one after another or one above another in some areas. The substances which are then superimposed can be used to form reinforcements with specific characteristics.

Alternatively or additionally to the use of different substances for forming reinforcements 22 with specific characteristics, it is possible to use at least one inhomogeneous substance which can be sprayed or is free-flowing. This inhomogeneous substance leads to the reinforcement applied to the material web 15 having different characteristics in different areas, in particular different cross-sectional areas (through the layer of reinforcement). In particular in the case of substances provided with additives, specific inhomogeneities can be formed in the reinforcements formed from these substances, for example by the additives assuming only a subarea of the cross section of the respective reinforcement 22. For example, if the reinforcement is formed of fibres which do not impair the free flow or sprayability of the substances, the visible outer side of the reinforcement 22 may be given an appearance similar to a nonwoven material by means of the substances. Furthermore, other additives and fillers are also conceivable.

Particular characteristics of the reinforcements 22 can also be achieved by the or each free-flowing substance being applied at a different thickness to the material web 15. As a result, it is firstly possible to provide different outer material blanks 17 with reinforcements 22 of different thicknesses which, overall, have the same thickness. Secondly, however, it is also possible to form the reinforcements 22 of a respective outer material blank 17 to have a different thickness in some areas. In this way, it is possible to structure the surface of the reinforcement 22, by which means, in particular, aesthetic styling possibilities are provided. In addition, the characteristics of the respective reinforcements 22 can be changed in some areas by means of different thicknesses of the latter.

After the reinforcements 22 have been produced on the material web 15 at the envisaged points and with the desired outlines by spraying on, printing on or the like with the material web 15 at a standstill or preferably moved onward continuously, the still liquid substances of the reinforcement 22 are consolidated in the drying station 13 by means of radiation, in particular heat. The reinforcements 22 formed in this way are then virtually equivalent to those which are formed by separate interlining blanks in the prior art. However, since the latter are dispensed with in the method according to the invention, the latter can be carried out very much more simply, specifically more quickly and without manual interventions, but also more precisely and in a more space-saving way.

Following the consolidation of the reinforcements 22 in the drying station 13, in the following cutting device 14 the reinforced outer material blanks 17 are cut out of the material web 15 by at least one computer-controlled cutting means 20. For this purpose, the cutting means 20 or, if appropriate, also a plurality of cutting means is moved in the manner of a cutting plotter along the outlines of the outer material blanks 17, and the outer material blanks 17 are cut out of the material web 15 by means of circumferential cut edges 21. Like the reinforcement, the cutting out of the outer material blanks 17 from the material web 15 is carried out with the material web 15 at a standstill or preferably continuously moved onward. If the reinforcement is carried out with the material web 15 continuously moved onward, the cutting out of the outer material blanks 17 also takes place with the material web 15 moved onward continuously. The same applies to the reinforcement and cutting out of the material web 15 which, if appropriate, can at the same time be carried out during a similar stop phase of the material web 15. As a result of the previous application of the reinforcements 22, the outer material blanks 17 are cut out of the material web 15 at the same time as the reinforcements 22. In the process, in the areas of reinforcements 22, the same are hemmed externally, so that the outer material blanks 17 and the reinforcements 22 terminate at the correct edge and, by means of the reinforcements 22, the cut edges 21 are consolidated in order to prevent fraying. In particular in the case of outer material blanks 17 with reinforcements 22 in some areas, it is advantageous when applying the reinforcements 22, at least in the areas where no reinforcement 22 is located on the outer material blanks 17, to perform chemical consolidation of those areas of the material web 15 in which the cut edges 21 subsequently run. This chemical consolidation can be performed by the applicator device 12 or else by the cutting device 14, specifically before the cutting means 20 of the same cut the material web 15 at the relevant point.

In addition, provision can be made to fix the material web 15 against slipping on the worktop 10, for example by means of suction, at least during the spraying on of the reinforcements 22 and the cutting out of the outer material blank 17. It is sufficient for this fixing to be carried out at least in the area of the applicator device 12 and of the cutting device 14, to be specific in each case preferably over the entire area there, Such fixing of the material web 15 on the worktop 10 by means of vacuum or the like is particularly advantageous if the reinforcements 22 are sprayed onto the material web 15 and the latter is cut with the material web 15 at a standstill on the worktop 10.

The method according to the invention can also be carried out on different apparatus from those shown in FIGS. 1 and 2. In addition, it is possible to use the method according to the invention to reinforce two-dimensional textile structures which are not used for the production of items of clothing. Finally, however, it is also conceivable to reinforce any other desired two-dimensional flat structures, that is to say not just two-dimensional textile structures, with the method according to the invention.

1. Method of reinforcing flat materials, in particular two-dimensional textile structures such as outer materials or the like, the materials being provided with a reinforcement having predefined outlines, characterized in that at least one substance forming the reinforcement (22) is applied in a specifically positioned manner, in the free-flowing state, to the material to be reinforced.

2. Method according to claim 1, characterized in that the at least one free-flowing substance is applied to the material under computer control.

3. Method according to claim 1, characterized in that the at least one substance is applied to the material by a computer-controlled applicator device (12).

4. Method according to claim 1, characterized in that the at least one free-flowing substance is printed onto the material.

5. Method according to claim 1, characterized in that the at least one free-flowing substance is sprayed onto the material.

6. Method according to claim 1, characterized in that the at least one substance is applied with the envisaged outlines at the relevant point on the material.

7. Method according to claim 6, characterized in that the at least one substance is applied with the envisaged outlines to the entire area at the relevant point on the material.

8. Method according to claim 3, characterized in that the at least one substance is applied to the material by means of at least one applicator nozzle (18) which belongs to the applicator device (12) and the course of whose path can be controlled.

9. Method according to claim 1, characterized in that the reinforcement (22) is applied to a material web (15) of the material to be reinforced.

10. Method according to claim 1, characterized in that the reinforcement (22) is applied to a blank of the material to be reinforced.

11. Method according to claim 9, characterized in that after the application of the reinforcement (22), the flat materials are cut out of the material web (15) in order to form the reinforced blanks.

12. Method according to claim 10, characterized in that the at least one reinforcement (22) extends over the entire area of the respective blank.

13. Method according to claim 10, characterized in that the blanks are cut out of the material web (15) along the outlines of the reinforcements (22), the cut edges (21) running through the edge region of the respective reinforcement (22).

14. Method according to claim 10, characterized in that, between the application of the respective reinforcement (22) to the material and the cutting out of the blanks from the material, the at least one substance used for reinforcement is dried.

15. Method according to claim 1, characterized in that the at least one reinforcement (22) is formed from substances having different characteristics.

16. Method of reinforcing flat materials, in particular two-dimensional textile structures such as outer material or the like, the materials being provided with a reinforcement having predefined outlines, characterized in that the respective reinforcement (22) is formed from substances having different characteristics.

17. Method according to claim 16, characterized in that the respective reinforcement (22) is formed of inhomogeneous substances having different characteristics.

18. Method according to claim 1 or 16, characterized in that the respective substance used to form at least one reinforcement (22) is applied with a different layer thickness to the material.

19. Method according to claim 1 or 16, characterized in that different substances for reinforcing the material are used in some areas.

20. Method according to claim 19, characterized in that at least one substance which has additives is used.

21. Method according to claim 20, characterized in that the additives to the substance are formed of at least fillers.

22. Method according to claim 1 or 16, characterized in that a large number of reinforcements (22) is applied to a continuous material web (15).

23. Method according to claim 1 or 16, characterized in that the material web (15) is led cyclically at least past the applicator device (12) for the reinforcement (22), the onward transport of the material web (15) being interrupted during the application of the reinforcement (22).

24. Method according to claim 1 or 16, characterized in that during the application of the respective reinforcement (22) to the stationary material web (15), the material web is fixed to a support.
